(19) United States
(12) Patent Application Publication
(10) Pub. No.: US 2025/0334684 A1
(43) Pub. Date: Oct. 30, 2025

(54) Pivot Pole

(71) Applicant: BRENT HOFFMAN, Taylorsville, UT (US)

(72) Inventor: BRENT HOFFMAN, Taylorsville, UT (US)

(21) Appl. No.: 19/188,778

(22) Filed: Apr. 24, 2025

Related U.S. Application Data
(60) Provisional application No. 63/640,309, filed on Apr. 30, 2024.

(51) Int. Cl. G01S 7/521; A01K 61/95; F16M 11/06; G01S 15/96

(52) U.S. Cl. CPC G01S 7/521; A01K 61/95; F16M 11/06; G01S 15/96

(57) ABSTRACT

Pivot pole has upper handle, lever rotates about a single axis that transmits force to a lower-end pole linkage assembly that pivots the submerged transducer along two axes. By moving and twisting the invention's handle-knob at the upper end of the tiller arm in a forward backward direction, the transducer then moves from Perspective mode—angled 11 degrees downward from the water plane—to Forward mode—angled upward about 22 degrees from the water plane—to Down mode—parallel to the water plane, targeting the region immediately beneath the boat. Once positioned in one of these three modes, the handle knob is rotated to tighten its position, therein stabilizing the submerged transducer even in chop. The two-axis movement is achieved via the pivot pole's two internal cables configured into a series of pulleys connected within the pole's linkage assembly, further comprising an array of springs, pins, magnets, shims, bolts, rollers, bushings, plates and shafts. The pivot pole's internal configuration allows a simple back and forth movement of the handle lever to transmit force to the lower linkage assembly creating a piston-like action between the upper and lower assemblies, producing two-axes directional movement in the transducer below.

### CLAIM OF PRIORITY

This application currently claims priority to no prior U.S. patent applications.

### TECHNICAL FIELD

This disclosure relates to the technical field of rotating and pivoting poles and mounts for “fish finding” transducers, as well as rotating/pivoting poles and mounts for any device requiring 360° motion along two-axes with optional “fixed” positions therein.

### BACKGROUND OF THE INVENTION

A transducer is the heart of a fish finder system, changing electrical pulses into sound waves or acoustic energy and back again. It is the device that sends out the sound waves and then receives the echoes, so the fish finder can interpret what is below the surface of the water.

The transducer must ordinarily be mounted to a bracket, which is attached to a pole and substantially submerged.

Inter alia, The Garmin™ model LVS 34 is an example of a popular fish finding transducer. These types of transducers are designed to be submerged, mounted to a pole; the pole rises out of the water to be manipulated “over the side” of the boat.

The Garmin™ is but one example of many (manually) adjustable transducers, capable of being positioned such that their operative “face” points in a variety of positions so the fisherman can rotate the position of the transducer on its mount so they can “see” what's below in different directions (e.g. “down, perspective, forward”). Since the transducer is mounted to the pole below the water, the fisherman customarily needs to pull up the whole works to adjust the transducer position on its mount before re-submerging the pole.

For example, on the Garmin™-LVS34, the fisherman must:
Remove the pole/transducer from the water.
Dismantle one or both mounting bracket thumb screws.
Reposition the transducer.
Re-Tighten everything.
Re-submerge the pole/transducer.

Until now, even the best custom “over the side” pole-mount systems comprise a generic pole shaft, a boat-connecting plate and collar, and a tiller-style lever comprising a handle with knob. Heretofore, without following the cumbersome laborious steps above, the most these systems could do was to simply rotate a generic-submerged-mount along but one axis (like swiveling one's head 360° without looking up/down or cocking one's head slightly-sideways).

What is needed is a pivoting pole which allows the fisherman to instantly adjust the direction-position of the submerged transducer from the tiller-lever's knob (already in his hand) so that the transducer face can easily point in any direction along two axes, so the fisherman can truly see everything below from the comfort of his chair.

The herein-disclosed “pivot pole” features a handle whose lever rotates about a single axis that transmits force to a lower-end pole linkage assembly that pivots the submerged transducer along two axes. By simply moving and twisting the invention's handle-knob at the end of the tiller-lever arm forward or backward, the transducer then moves from Perspective mode (angled 11° downward from the water plane) to Forward mode (angled upward about 22° from the water plane) to Down mode (parallel to the water plane, targeting the region immediately beneath the boat).

Once the handle lever of the upper pivot-arm assembly is positioned in one of these three modes (transducer's fixed positions indicated by dead stops along two axes), the handle knob is rotated to tighten its position (therein stabilizing the submerged transducer during even choppy trolling).

The above adjustability is achieved via the pivot pole's two internal cables configured into a series of pulleys connected within the pole's linkage assembly, further comprising an array of springs, pins, magnets, shims, bolts, rollers, bushings, plates and shafts. The pivot pole's internal configuration allows a simple “back/forth” movement of the handle lever to transmits force to the lower linkage assembly creating a piston-like action between the upper and lower assemblies, producing two-axes directional movement in the transducer below

### BRIEF DESCRIPTION OF THE DRAWINGS

FIG. 1 is a perspective view of the herein-disclosed pivot pole assembly, consistent with various embodiments.

FIG. 2 is a partially-exploded perspective view of the pivot pole sub assembly, consistent with various embodiments.

FIG. 3 is a perspective view of the lower end pole assembly, consistent with various embodiments.

FIG. 4 is an exploded view of the lower end pole sub-assembly, consistent with various embodiments.

FIG. 5 is a perspective view of the upper pivot arm assembly, consistent with various embodiments.

FIG. 6 is an exploded view of the upper pivot arm sub-assembly, consistent with various embodiments.

FIG. 7 is a prototype perspective view of one embodiment of the invention, featuring the transducer in Forward mode. As shown by the right-side arrows, the handle rotates about an axis that transmits force to the linkage that pivots the transducer. As shown by the left-side arrows, Transducer shown in ‘Forward Mode’ (22° degree tilt).

FIG. 8 is a prototype perspective view of one embodiment of the invention, highlighting the positioning of the transducer face. FIG. 8's lone arrow shows operative feature-position/transducer face.

FIG. 9 is a prototype perspective view of one embodiment of the invention, featuring the lever-shaft in Perspective mode, shown with arrow to “P.”

FIG. 10 is a prototype perspective view of one embodiment of the invention, highlighting the twisting-fixing capacity of the handle. Traducer face is highlighted by arrow.

FIG. 11 is a prototype perspective view of one embodiment of the invention, highlighting the lever-shaft in Down mode, indicated by arrow to “D.”

FIG. 12 is a prototype perspective view of one embodiment of the invention, showing the transducer face in Forward mode. Traducer face is highlighted by arrow.

FIG. 13 is a prototype perspective view of one embodiment of the invention, showing the handle and lever-shaft in Forward mode, position highlighted by “F.”

FIG. 14 is a CAD prototype perspective view of one embodiment of the invention, featuring optional transducer directional indicator and optional boat bracket mount. Note the clamp-style mount is detachable and allows 360° movement around a third axis (herein pitch). The directional indicator is herein shown as a detachable collared star-shaped indicator, allowing for additional positions if needed.

FIG. 15 is an older-model plan view of the three directional modes of the transducer, consistent with various embodiments.

### DETAILED DESCRIPTION OF THE DRAWINGS

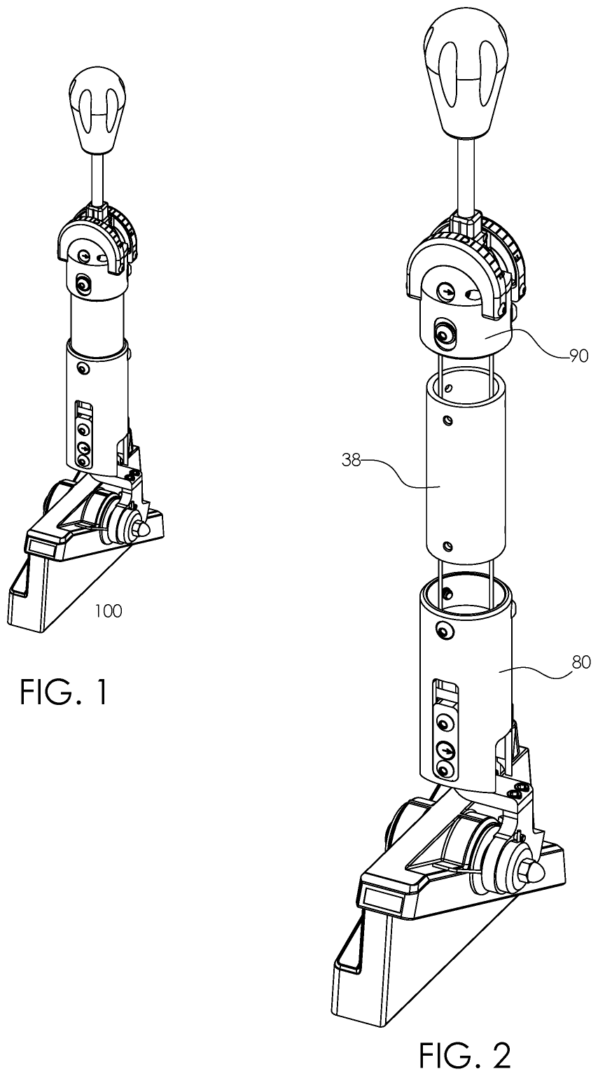

FIG. 1 is an external perspective view of the herein-disclosed pivot pole assembly 100, whose internal components are described infra.

FIG. 2 is a partially-exploded perspective view of the pivot pole sub-assembly comprising, in one

embodiment, the following components (listed by reference number):
38 . . . extension tube
80 . . . Lower pole sub-assembly
90 . . . Upper pivot-arm sub-assembly

The interaction of these components are described infra.

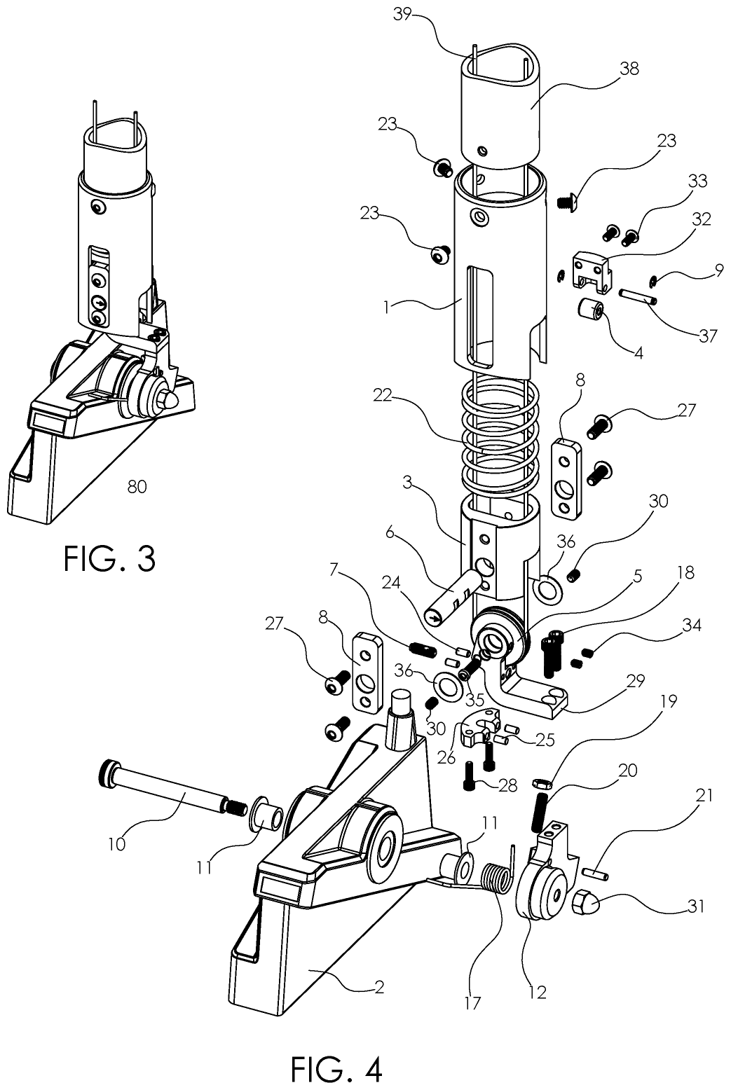

FIG. 3 is an (external) perspective view of the Lower-End Pivot Pole Assembly 80, whose internal components are described infra.

FIG. 4 illustrates the Lower End Pole Sub-Assembly comprising, in one embodiment, the following components: (listed by reference number):
1 . . . lower pole housing
2 . . . transducer (not claimed)
3 . . . upper side anchor
4 . . . idle roller
5 . . . cable pulley
6 . . . cross shaft
7 . . . ball set screw
8 . . . side pad
9 . . . E clip
10 . . . shoulder bolt
11 . . . bushing
12 . . . trans side
17 . . . torsion spring
18 . . . SHCS (“socket head cap screw”) lower body
19 . . . jam nut
20 . . . oval tip screw
21 . . . torsion spring pin (dowel pin)
22 . . . compression spring
23 . . . BHCS (“button head cap screw”) screw
24 . . . magnets
25 . . . magnets
26 . . . dead stop
27 . . . PH (“Phillips head”) screw
28 . . . SHCS (socket head cap screw) stop
29 . . . lower sensor pivot
30 . . . cable pinch screw
31 . . . acorn nut
32 . . . roller wheel holder
33 . . . roller screw
34 . . . shaft screw
35 . . . SHCS (socket head cap screw) pulley lock
36 . . . shim
37 . . . pin shaft
38 . . . extension tube
39 . . . transfer cable

Inter alia, the engineering, design and configuration of components pivot 29, shcs stop 28, transfer cable 39 and the other relevant components accomplish the “rotating action” (first axis) and the “pivoting action” (perpendicular second-axis movement) of the Transducer 2.

Specifically, the cable 39 is locked to the pulley 5 by the set screw 30. The upper pulley 58 is locked to the same cable 39 with set screw 63. On the upper assembly, the force on the open-ended (non-crimped) cable 5 transmits to the lower assembly.

Attaching the upper and lower pulleys 58 to the cable 5 places the force on the lower pivot arm 29. The cross shaft 6 allows the lower sensor pivot 29 and cable pulley 5 (now attached to lower-sensor pivot 29) to pivot about upper slide anchor 3, creating the attachment between lower and upper sections, therein creating the pivoting/rotation action of lower sensor pivot 29 and cable pulley 5. (*The screw/shcs pulley-lock 35 holds pivot 29 and cable 5 together). Before rotational force is applied, cross pin 6 and upper slide anchor 3 must be affixed and positioned inside anchor 3 in order to secure and rotate about the upper slide anchor 3.

The set screw 63 is threaded through the main slide plate 56 which pinches the cables 5 such that the dual-pulley 58 can function.

Dead stop 26 attaches to anchor 3 via screws/SHCS stops 28, which are securely fixed to the face/tip of upper anchor 3.

In addition, (adjustable) ball set screw/stop 7 is attached to pivot 29 such that, upon pivoting, the lower-apparatus (including transducer 2) naturally stops rotating at lower pole housing 1. This bracket/pivot 29 also allows slight adjustment and angle movement of the transducer 2.

Torsion spring 17 puts pressure on the oval tip screw 20, giving the transducer 2 a fixed positioning point, e.g. perfectly perpendicular to the center line axis of the pole.

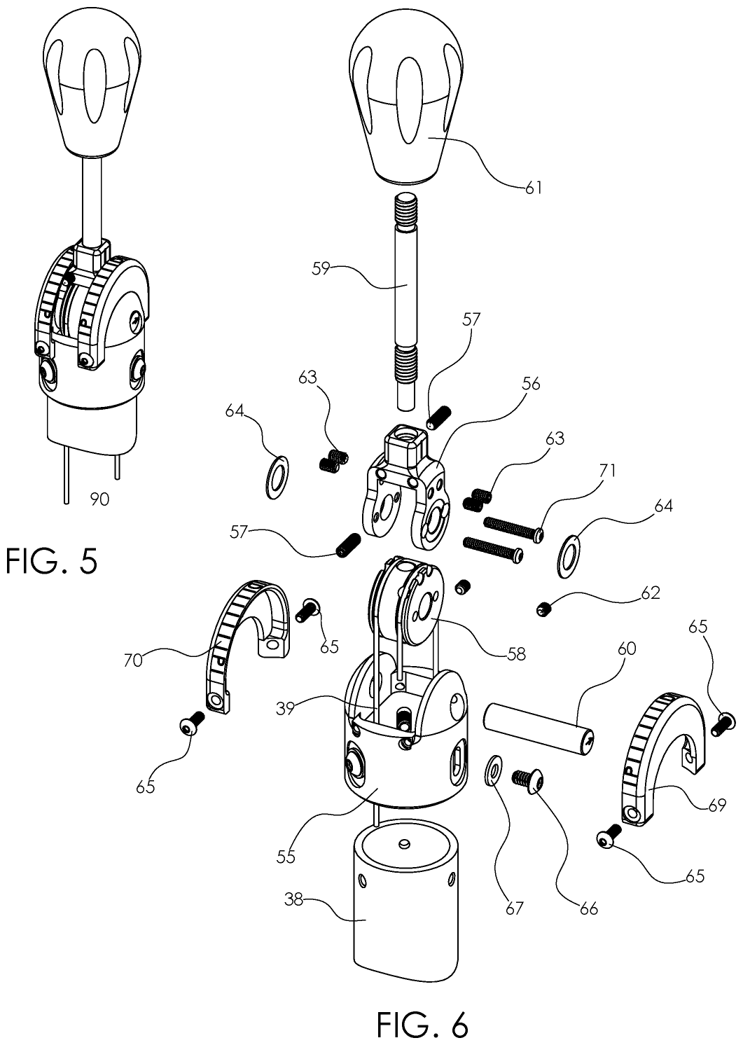

FIG. 5 is a perspective view of the upper pivot arm assembly 90, consistent with various embodiments. The illustration features the one-axis lever arm and twisting handle, described infra. The key feature of this upper assembly is that, while the handle moves along one axis, the invention's mechanism (described supra and infra) forces transducer 2 movement in two directions [along two axes (both pitch and yaw)].

FIG. 6 illustrates the Upper Pivot Arm Assembly, comprising, in one embodiment, the following components: (listed by reference number):
38 . . . extension tube
39 . . . transfer cable
55 . . . main upper bracket
56 . . . main side plate
57 . . . oval adjuster/stop pin for three-positions (adjustable)
58 . . . dual pulley
59 . . . turn shaft
60 . . . cross pin
61 . . . knob
62 . . . cross pin screw
63 . . . cross pin screw
64 . . . shim 2
65 . . . BHCS 1
66 . . . BHCS pole
67 . . . washer
69 . . . scale cover 1
70 . . . scale cover 2
71 . . . BHCS Long

Inter alia, the engineering, design and configuration of operative components (as shown) accomplish the “rotating action” (first axis) and the “pivoting action” (perpendicular axis movement) of the Transducer 2.

Force on main side plate 56 and turn shaft 59 via knob 61 transmits force through the cables 39 down to the lower assembly. The set screw 63 pinches on the dual pulley 58 and secures the cable 5 to transmit force to the lower assembly. Dual pulley 58 and cross pin 60 are held together by BHCS screws 71 to lock components together to key main slide plate 56 and pulley 58 together.

The “pivot pole” features a handle 61 whose lever/turn-shaft 59 rotates about a single axis that transmits force to a lower-end pole linkage assembly that pivots the submerged transducer along two axes.

To achieve the Forward or Down or Perspective modes, one simply rotates the invention's knob at the end of the tiller-lever arm forward or backward. Markings near the tiller-lever will indicate their respective positions (P-F-D). Simultaneously the transducer 2 moves to Perspective mode (‘P’ angled 11° downward from the water plane) or Down mode (‘D’ parallel to the water plane, targeting the region immediately beneath the boat) or Forward mode (‘F’ angled upward about 22° from the water plane).

* (Not limited to just Garmin LVS 34 and LVS 62 Live Scope™, it also fits the Lowrance Active™ Target Live™, and Humminbird™ Mega Live™. Possibly other manufacturers as well).

The adjustable three-position “dead stops” are substantially accomplished via the engineering, design and positioning of the operative components as shown in FIG. 6, which are then “fixed” via rotation of the handle 61, which turns to squeeze operative internal components at the designated positions to fix the position for Transducer 2 stability.

The dead stop in “D” down position is accomplished by dead stop 26, since the back side of the lower sensor pivot 29 and the magnets 25 hold the invention in its “D” position (down position).

Moving from “D” position, screws/oval adjusters 57 stop the handle from over-rotating beyond the pole's factory settings (in both the “P” and “F” positions).

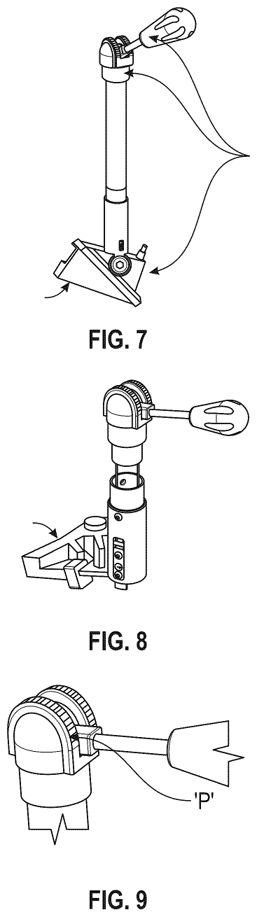

FIG. 7 is a prototype perspective view of one embodiment of the invention, featuring the transducer in Forward mode. As shown by the right-side arrows, the handle rotates about an axis that transmits force to the linkage that pivots the transducer. As shown by the left-side arrows, Transducer shown in ‘Forward Mode’ (22° degree tilt).

FIG. 8 is a prototype perspective view of one embodiment of the invention, highlighting the positioning of the transducer face. FIG. 8's lone arrow shows operative feature-position/transducer face.

FIG. 9 is a prototype perspective view of one embodiment of the invention, featuring the lever-shaft in Perspective mode. Perspective mode shown with arrow to “P.”

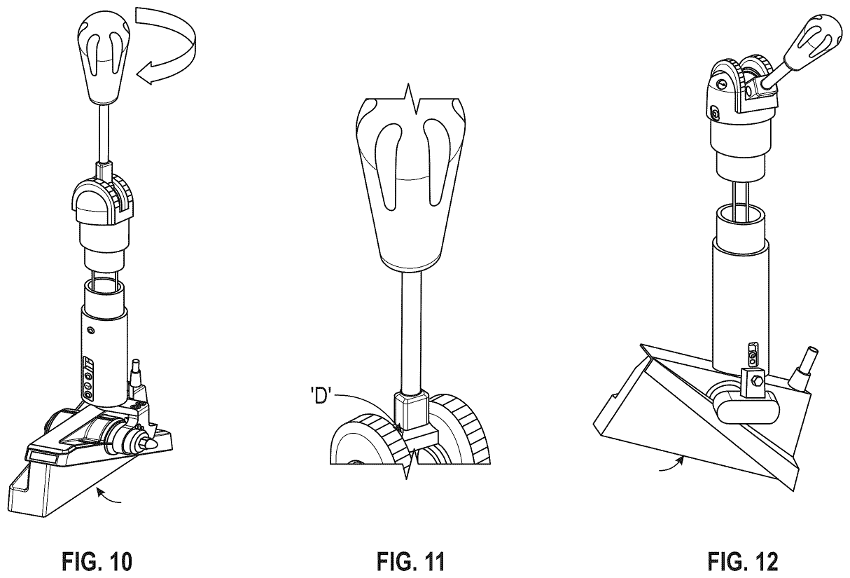

FIG. 10 is a prototype perspective view of one embodiment of the invention, highlighting the twisting-fixing capacity of the handle. Traducer face is highlighted by arrow.

FIG. 11 is a prototype perspective view of one embodiment of the invention, highlighting the lever-shaft in Down mode. Down mode indicated by arrow to “D.”

FIG. 12 is a prototype perspective view of one embodiment of the invention, showing the transducer face in Forward mode. Traducer face is highlighted by arrow.

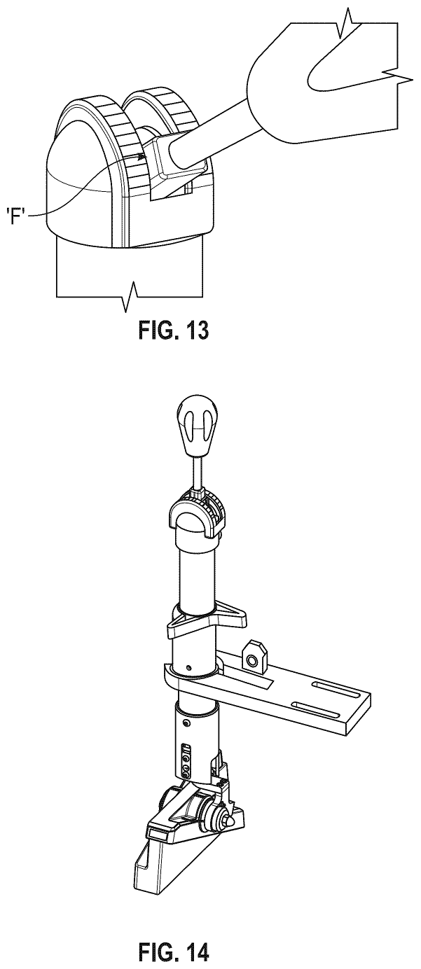

FIG. 13 is a prototype perspective view of one embodiment of the invention, showing the handle and lever-shaft in Forward mode, highlighted by “F.”

FIG. 14 is a CAD prototype perspective view of one embodiment of the invention, featuring optional transducer directional indicator and optional boat bracket mount. Note the clamp-style mount is detachable and allows 360° movement around a third axis (herein pitch). The directional indicator is herein shown as a detachable collared star-shaped indicator, allowing for additional positions if needed.

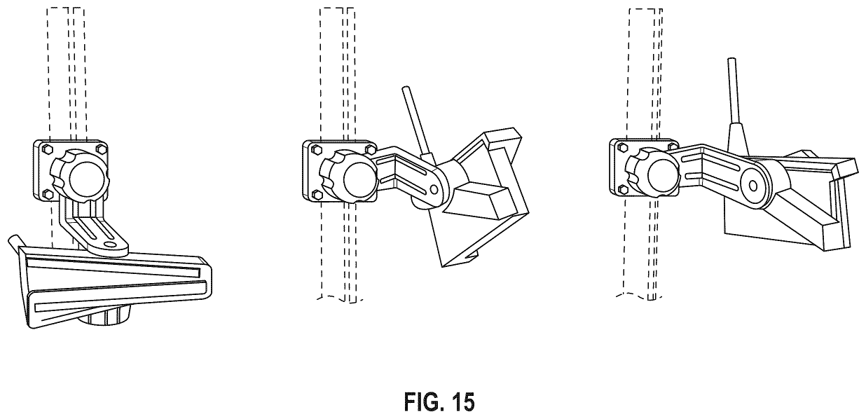

FIG. 15 is an older-model plan view of the three directional modes of the transducer, consistent with various embodiments.

Note that alternate embodiments may comprise motorized or wireless drives for directional manipulation.

### Specifications Generally

In the Summary above and in this Detailed Description, and in the accompanying illustrations and drawings, reference is made to particular features of various embodiments of the invention. It is to be understood that the disclosure of embodiments of the invention in this specification includes all possible combinations of such particular features.

For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In various embodiments, elements described herein as coupled or connected may have an effectual relationship realizable by a direct connection or indirectly with one or more other intervening elements.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure.

Certain terminology and derivations thereof may be used in the present disclosure for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an embodiment “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as may be described herein-above may be used. Many suitable materials are known and available and can be selected and mixed depending on desired strength and flexibility, preferred manufacturing method and particular use, as will be apparent to a person of ordinary skill in the art.

Any element in a claim herein that does not explicitly state “means for” performing a specified function, or “step for” performing a specific function, is not to be interpreted as a “means” or “step” clause as specified in 35 U.S.C. § 112 (f). Specifically, any use of “step of” in the claims herein is not intended to invoke the provisions of 35 U.S.C. § 112 (f). Elements recited in means-plus-function format are intended to be construed in accordance with 35 U.S.C. § 112 (f).

Recitation in a claim of the term “first” with respect to a feature or element does not necessarily imply the existence of a second or additional such feature or element.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim in this or any application claiming priority to this application require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components.

The herein-disclosed “pivot pole” features an upper handle whose lever rotates about a single axis that transmits force to a lower-end pole linkage assembly that pivots the submerged transducer along two axes. By simply moving and twisting the invention's handle-knob at the upper end of the tiller-lever arm in a simple forward/backward direction, the transducer then moves from Perspective mode (angled 11° downward from the water plane) to Forward mode (angled upward about 22° from the water plane) to Down mode (parallel to the water plane, targeting the region immediately beneath the boat).

Once the handle lever of the upper pivot-arm assembly is positioned in one of these three modes (transducer's fixed positions indicated by dead stops along two axes), the handle knob is rotated to tighten its position (therein stabilizing the submerged transducer during even choppy trolling). The two-axis movement is achieved via the pivot pole's two internal cables configured into a series of pulleys connected within the pole's linkage assembly, further comprising an array of springs, pins, magnets, shims, bolts, rollers, bushings, plates and shafts. The pivot pole's internal configuration allows a simple “back/forth” movement of the handle lever to transmit force to the lower linkage assembly creating a piston-like action between the upper and lower assemblies, producing two-axes directional movement in the transducer below.

1. A pivot pole which allows a deep sea fish finding device to move in 360° directions by virtue of digital manipulation from the surface boat position.
